(19) United States
(12) Patent Application Publication
(10) Pub. No.: US 2013/0078047 A1
(43) Pub. Date: Mar. 28, 2013

(54) FAST CHANGEABLE WORKTABLE OF A CARVING MACHINE

(71) Applicant: Bor-Yann CHUANG, Taichung City (TW)

(72) Inventor: Bor-Yann CHUANG, Taichung City (TW)

(21) Appl. No.: 13/241,641

(22) Filed: Sep. 23, 2011

(51) Int. Cl. B23Q 1/44

(52) U.S. Cl. 409/219

(57) ABSTRACT

A fast changeable worktable of a carving machine includes a bottom base having a sliding groove used to fit a main table, and a driving unit. Installed on each sidewall of the sliding groove is a first pressing portion tightly squeezing with a second pressing portion of the worktable, so that the worktable can be stably positioned without vibrating. And with a rack fixed on the bottom of the worktable to engage with a gear of the driving unit, the worktable can easily slide along the sliding groove for being swiftly replaced with a proper one if necessary.

### BACKGROUND OF THE INVENTION

1. Field of the Invention

This invention relates to a fast changeable worktable of a carving machine.

2. Description of the Prior Art

Commonly, a carving machine is used to create characters, pictures, etc. on a workpiece. As shown in FIG. 1, a conventional carving machine 200 is mainly composed of a bottom base 201, a worktable 202 set on the bottom base 201 to move along a Y axis, a rectangular column 203 installed above the worktable 202, an X-axial sliding base 204 set at one side of the rectangular column 203 to move along X axis, a Z-axial sliding base 205 set on the X-axial sliding base 204 to move along Z axis, and a knife 300 combined with the Z-axial sliding base 205. With the knife 300 moved precisely along X axis, Y axis and Z axis to locations expected, the carving machine 200 can do a carving according to what is required.

Next, as shown in FIG. 2, the conventional carving machine 200 is further provided with a pair of pivotal fixing bases 206 respectively positioned on two sides of the bottom base 201, a screw 207 pivotally installed between the pivotal fixing bases 206, and a motor 208 connected with one side of the screw 207. In addition, installed under the bottom base 201 is a driven base 209, which possesses a threaded hole 210 threadably engaged with the screw 207. So the motor 208 can drive the screw 207 to rotate, enabling the driven base 209 to be drawn by the screw 207 to move along Y axis. However operation of the carving machine mentioned above has the following disadvantages.

1. As a gap always exists between the screw 207 and the threaded hole 210 of the driven base 209, the worktable 202 is to vibrate easily while the carving machine 200 is operating, possible to unexpectedly displace the worktable 202 to downgrade working precision.

2. The worktable 202 is unchangeable because it is fixedly screwed with the bottom base 201. Thus for a workpiece longer than the worktable, the carving machine 200 cannot work for it.

### SUMMARY OF THE INVENTION

The object of this invention is to offer a fast changeable worktable of a carving machine, without vibrating while working.

The main characteristics of the invention are a bottom base, a main table and a driving unit. The bottom base possesses a sliding groove formed in a top with a pair of sidewalls respectively located at two opposite sides, and a bottom wall connecting the two sidewalls. At least one of the sidewalls is installed with a first pressing portion positioned axially along the sliding groove. And at least one end of the sliding groove is extended to an edge of the bottom base so as to correspondingly form an opening along the edge. The main table is fitted on the sliding groove, provided with a bottom surface, a top surface and two circumferential sides to correspond to the bottom base. A rack is fixed under the bottom surface, positioned axially along the sliding groove. A second pressing portion is located below each of the circumferential sides to mutually squeeze with the first pressing portion tightly. The driving unit is installed between the bottom base and the main table, provided with a driving shaft having a gear engaged with the rack of the main table.

With the gear engaged with the rack to enable the main table to slide on the sliding groove, the main table can be directly dragged out from one of the openings and reloaded with another one from the opening according to the length of a workpiece. And with the first pressing portion tightly squeezing with the second pressing portion, the worktable can work steadily without vibrating, assuring the gear of the driving unit to keep completely engaging with the rack of the main table from slipping, affecting precise position of the main table.

### BRIEF DESCRIPTION OF DRAWINGS

This invention is better understood by referring to the accompanying drawings, wherein:

FIG. 1 is a perspective view of a conventional carving machine;

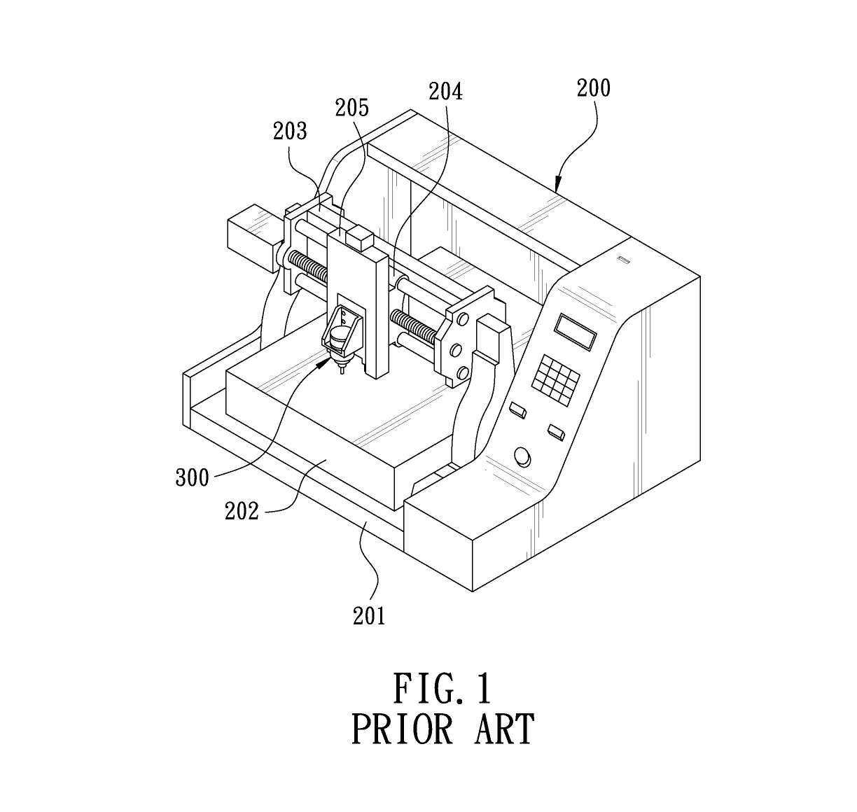

FIG. 2 is a cross-sectional view of the conventional carving machine;

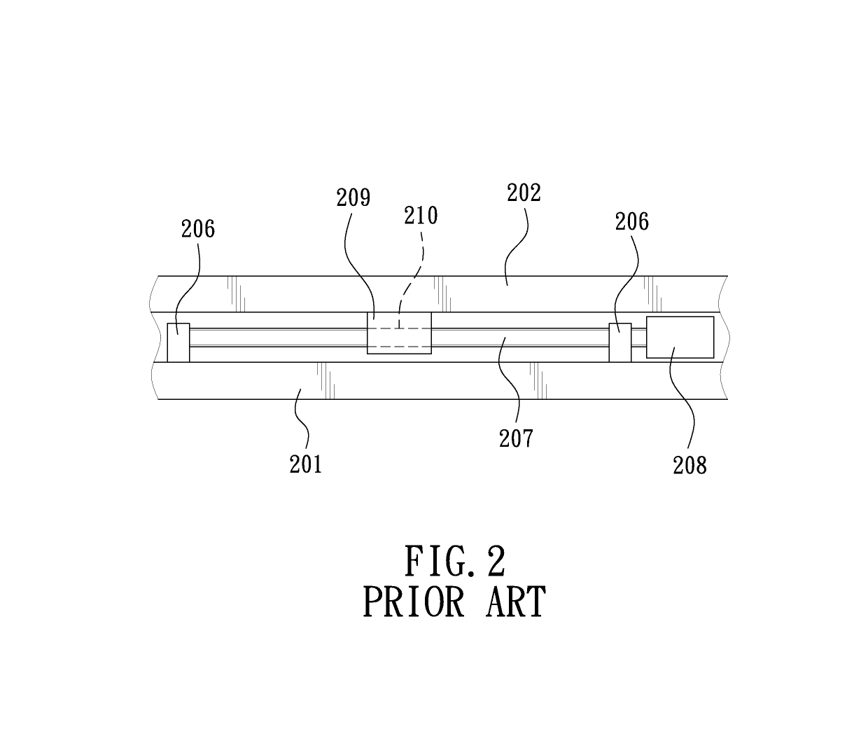

FIG. 3 is a perspective view of a preferred embodiment of a fast changeable worktable of a carving machine in the present invention, installed in a carving machine;

FIG. 4 is an exploded perspective view of the preferred embodiment of a fast changeable worktable of a carving machine in the present invention;

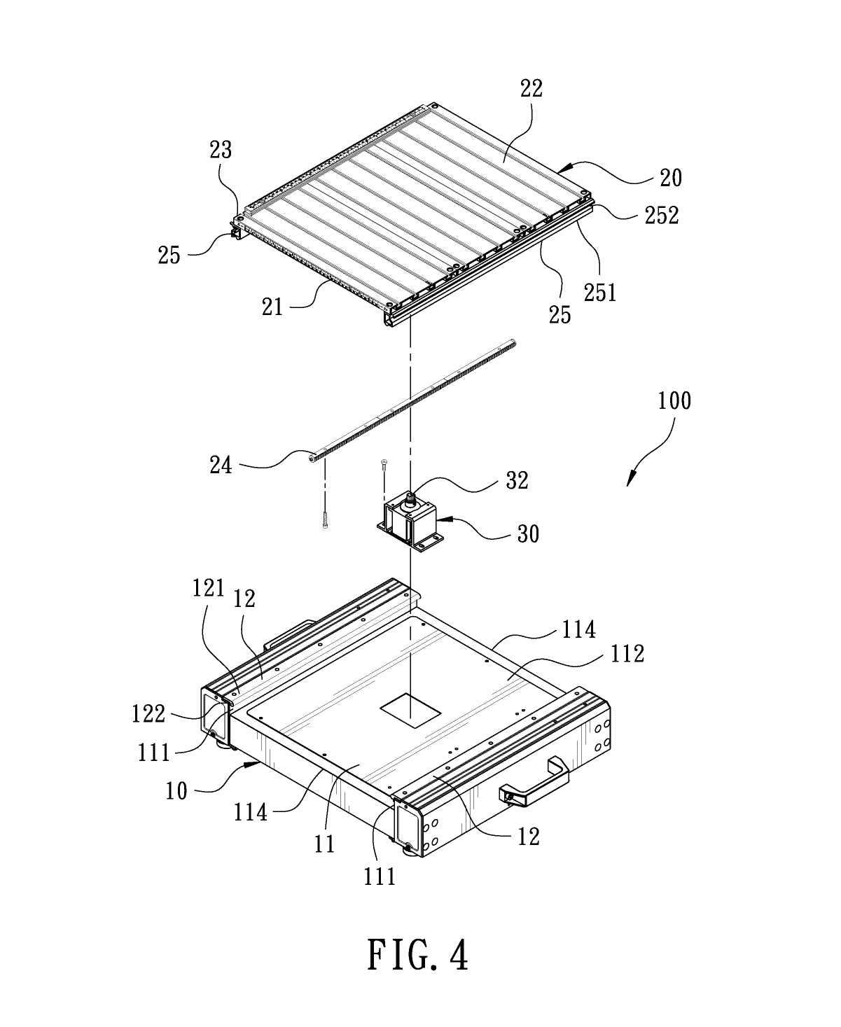

FIG. 5 is a cross-sectional view of the preferred embodiment of a fast changeable worktable of a carving machine in the present invention;

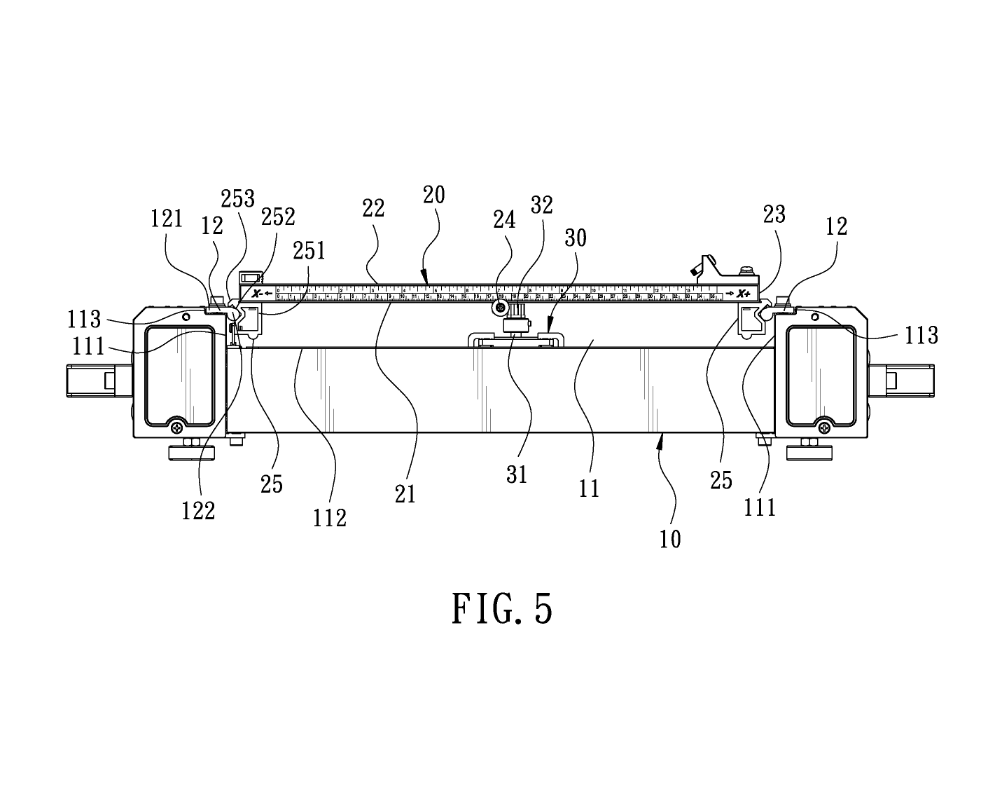

FIG. 6 is a partial cross-sectional view of the preferred embodiment of a fast changeable worktable of a carving machine in the present invention; and

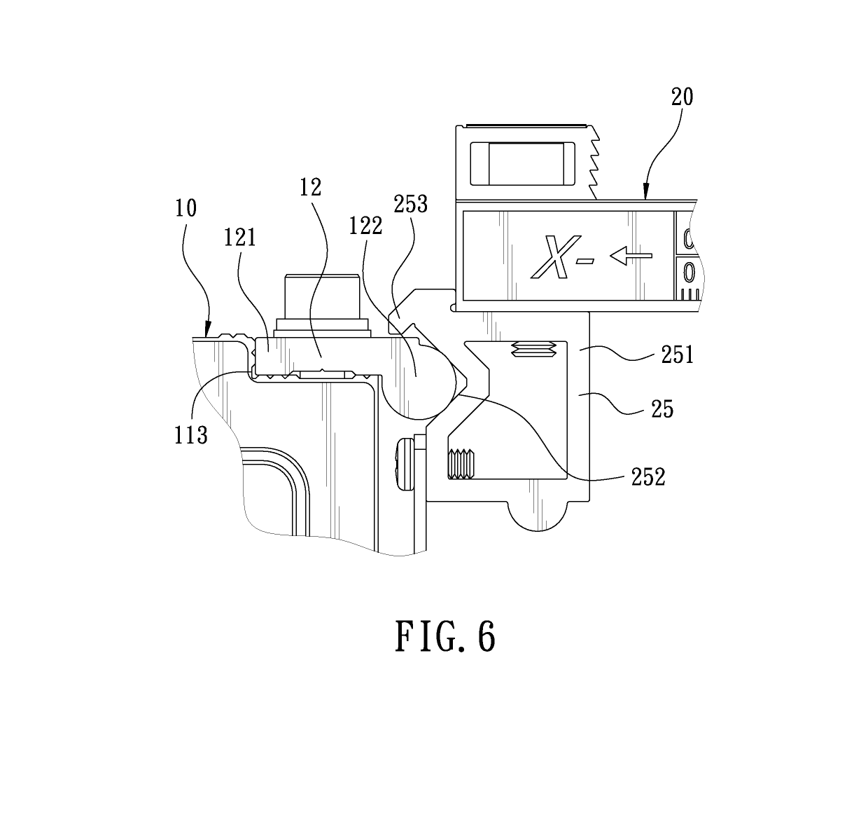

FIG. 7 is a perspective view of a preferred embodiment of a fast changeable worktable of a carving machine in the present invention, installed in a carving machine, showing a main table being drawn out of a sliding groove.

### DETAILED DESCRIPTION OF THE PREFERRED EMBODIMENT

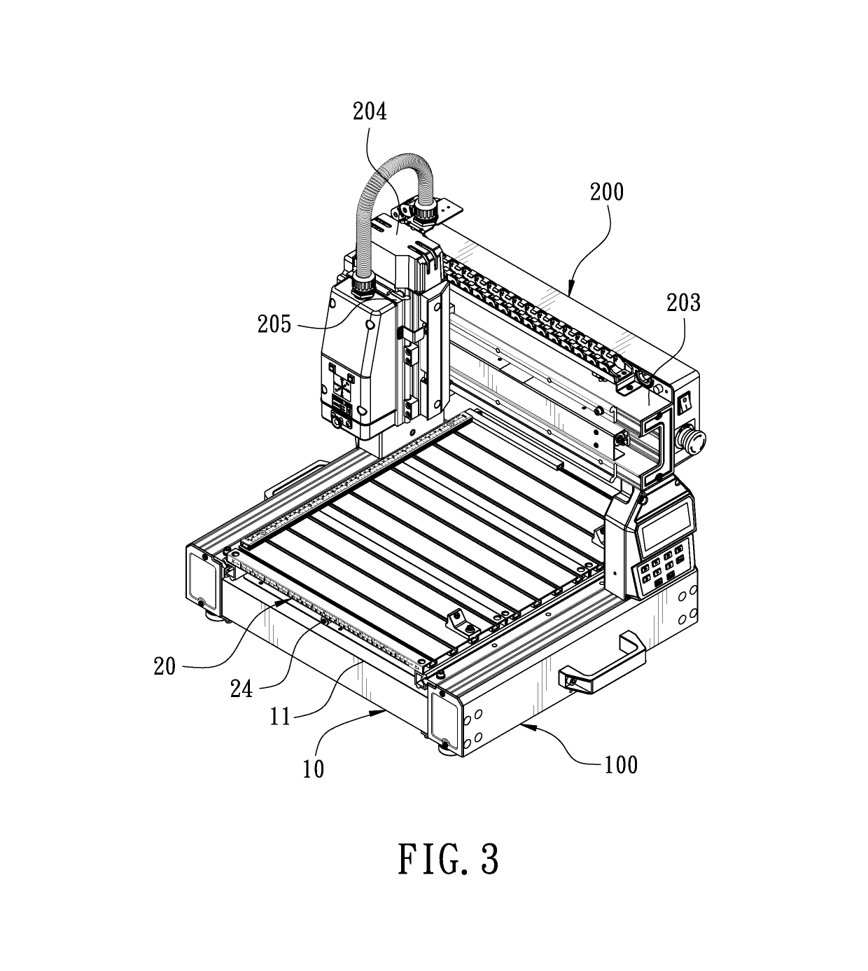

FIGS. 3˜6 show a preferred embodiment of a fast changeable worktable 100 of a carving machine in the present invention. The fast changeable worktable 100 is installed in a carving machine 200, which is the same as the one described in the prior art, not to be described at length. The fast changeable worktable 100 includes a bottom base 10, a main table 20 and a driving unit 30.

The bottom base 10 has a sliding groove 11 formed in the top. The sliding groove 11 is provided with a pair of sidewalls 111 respectively located at two opposite sides, a bottom wall 112 connecting the sidewalls 111, and a fixing groove 113 recessed outward from top of the sidewalls 111 respectively. At least one of the sidewalls 111 is installed with a first pressing portion 12 positioned axially along the sliding groove 11. The first pressing portion 12 includes a fixing plate 121 positioned in the fixing groove 113, and a restricting projection 122 extended from the fixing plate 121 toward another sidewall 111. In this embodiment of the invention, the first pressing portion 12 is set on each of the sidewall 111. At least one end of the sliding groove 11 is extended to an edge of the bottom base 10, so as to correspondingly form an opening 114 along the edge. In this embodiment of the invention, two ends of the sliding groove 11 are extended to two corresponding edges of the bottom base 10, with two openings 114 formed.

The main table 20 is fixed on the sliding groove 11, provided with a bottom surface 21, a top surface 22 and two circumferential sides 23 corresponding to the bottom base 10. Fixed under the bottom surface 21 is a rack 24 positioned axially along the sliding groove 11. The main table 20 is further provided with a second pressing portion 25 located below each of the circumferential sides 23 to mutually squeeze with the first pressing portion 12 tightly. In this embodiment of the invention, the second pressing portion 25 is provided with a fixing block 251 employed to be fixed with the circumferential side 23, a wedge-shaped groove 252 recessed in one side of the fixing block 251 to fit the restricting projection 122 of the first pressing portion 12, and a dustproof projection 253 obliquely extended down from an upper edge of the wedge-shaped groove 252.

The driving unit 30 is installed between the bottom base 10 and the main table 20, provided with a driving shaft 31 having a gear 32 engaging with the rack of the main table 20. In this embodiment of the invention, the driving unit 30 is positioned on the bottom wall 112 of the sliding groove 11.

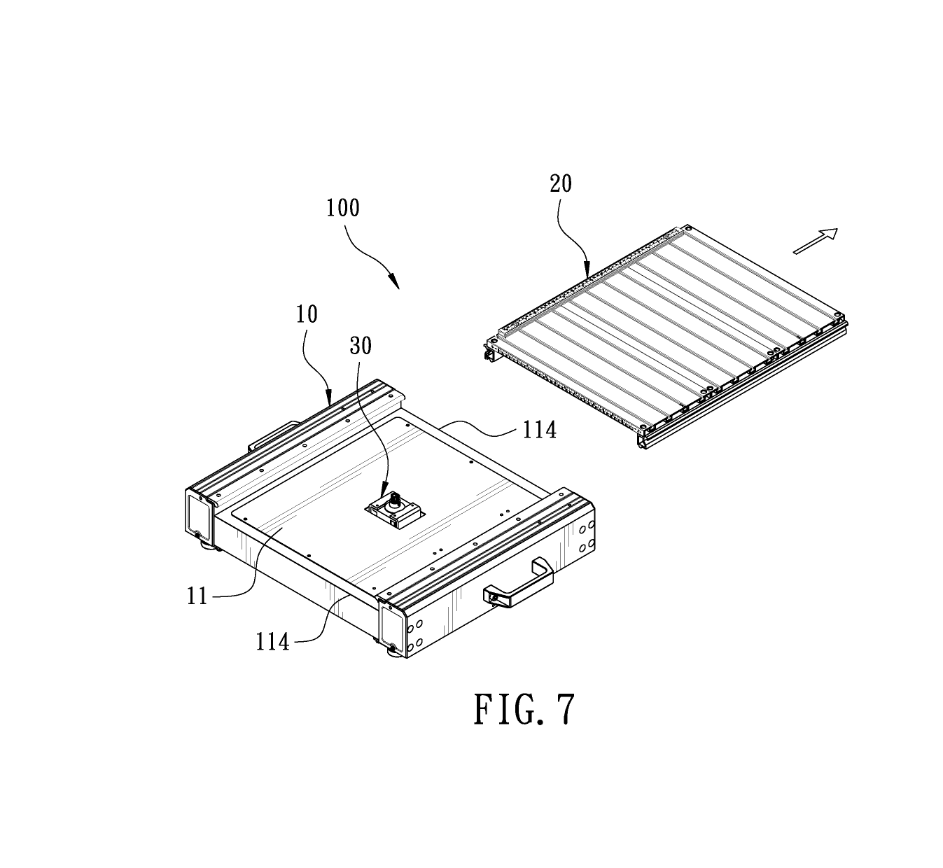

Next, as shown in FIG. 7, the driving unit 30 regularly has the gear 32 engaged with the rack 24 of the main table 20, able to drive the main table 20 to move along Y axis while the carving machine 200 is started up. By the time, as the restricting projection 122 of the first pressing portion 12 on the sidewall 111 is restrictively fitted as a wedge in the wedge-shaped groove 252 of the second pressing portion 25, so the second pressing portion 25 and the first pressing portion 12 can tightly squeeze with each other. Not only can the main table 20 be prevented from vibrating while the carving machine 200 is working, but the gear 32 of the driving unit 30 also can tightly engage with the rack 24 of the main table 20 to keep from slipping affecting precise position of the main table 20.

It should be noted that with the engagement of the gear 32 and the rack 24, the main table 20 can slide on the sliding groove 11 of the bottom base 10. If a workpiece to be carved is lengthier than the main table 20, the main table 20 can be directly dragged out from one of the openings 114 and replaced with a longer one reloaded on the sliding groove 11 through the opening 114. That is, various main tables 20 can be prepared and swiftly changed to cope with workpieces different in length, with a wide application for the changeable worktable 100.

Furthermore, with the dustproof projection 253 extended out from an edge of the wedge-shaped groove 252 of the second pressing portion 25, wastes cut off a workpiece can be prevented from entering the wedge-shaped groove 252 so as to keep the restricting projection 122 and the wedge-shaped groove 252 from deadlocking with each other or abrasively damaged.

While the preferred embodiment of the invention has been described above, it will be recognized and understood that various modifications may be made therein and the appended claims are intended to cover all such modifications that may fall within the spirit and scope of the invention.

What is claimed is:

1. A fast changeable worktable of a carving machine comprising:
a bottom base having a sliding groove formed in a top, said sliding groove provided with a pair of sidewalls respectively located at two opposite sides, a bottom wall connecting said sidewalls, at least one of said sidewalls installed with a first pressing portion positioned axially along said sliding groove, at least one end of said sliding groove extended to an edge of said bottom base so as to correspondingly form an opening along the edge;
a main table fixed on said sliding groove and provided with a bottom surface and a top surface and two circumferential sides to correspond to said bottom base, a rack fixed under said bottom surface and positioned axially along said sliding groove, a second pressing portion located below each of said circumferential sides to mutually squeeze with said first pressing portion tightly; and
a driving unit installed between said bottom base and said main table and provided with a driving shaft having a gear engaged with said rack of said main table.

2. The fast changeable worktable of a carving machine as claimed in claim 1, wherein said first pressing portion is provided with a fixing plate positioned on said sidewall and a restricting projection extended from said fixing plate toward another sidewall, said second pressing portion provided with a fixing block employed to be fixed with said circumferential side of said main table and a wedge-shaped groove recessed in one side of said fixing block to correspond to said restricting projection of said first pressing portion.

3. The fast changeable worktable of a carving machine as claimed in claim 2, wherein said second pressing portion is further provided with a dustproof projection extending out from an upper edge of said wedge-shaped groove.

4. The fast changeable worktable of a carving machine as claimed in claim 2, wherein said sidewall has a top recessed with a fixing groove utilized to fix said fixing plate of said first pressing portion.

5. The fast changeable worktable of a carving machine as claimed in claim 1, wherein each of said sidewalls of said bottom base has a first pressing portion corresponding to a second pressing portion formed at each of circumferential sides of said main table.

6. The fast changeable worktable of a carving machine as claimed in claim 1, wherein two ends of said sliding groove are respectively extended to two edges of said bottom base with an opening formed along each edge of said bottom base.
